(19) United States
(12) Patent Application Publication
(10) Pub. No.: US 2010/0236110 A1
(43) Pub. Date: Sep. 23, 2010

(54) AUTOMATICALLY COOLING IRON

(75) Inventor: Chih-hwa LEE, Tainan City (TW)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/726,538

(22) Filed: Mar. 18, 2010

(30) Foreign Application Priority Data
Mar. 18, 2009 (CN) 200910111337.9

(51) Int. Cl. D06F 75/08; H05B 1/02

(52) U.S. Cl. 38/82; 219/509

(57) ABSTRACT

An automatically cooling iron has: a housing with an electric heating plate on the bottom, a fan inside of the housing, a motion status detector and an automatic switch circuit. The motion status detector is a ball switch providing three kinds of status information: statically and horizontally placing/statically and vertically standing/motion. The automatic switch circuit has a heating switch, a fan switch and a microprocessor. The microprocessor calculates horizontally placing time or vertical standing time according to the information of statically and horizontally placing/statically and vertically standing/motion provided by said ball switch, and if the horizontally placing time or vertical standing time reaches a predetermined value, the microprocessor controls the heating switch to cut off power to the electric heating plate and controls the fan switch to turn on the fan.

### FIELD OF THE INVENTION

The present invention relates to an electric iron.

### BACKGROUND OF THE INVENTION

Traditional electric iron has an electric heating plate on the bottom of the housing. In ironing, the electric heating plate of the iron has high temperature; after the ironing is stopped, the electric heating plate needs long time to be cooled so as to be stored safely.

### SUMMARY OF THE INVENTION

The primary object of the present invention is to provide an automatically cooling iron which is capable of being automatically cooled after stopping using so as to be stored quickly.

The object is achieved by providing: An automatically cooling iron comprising a housing, an electric heating plate disposed on the bottom of said housing, the inside of the housing is disposed with a fan\ a motion status detector and an automatic switch circuit; said motion status detector provides the signal of the stopping of the iron to said automatic switch circuit, said automatic switch circuit is used to calculate the time of the stopping and controls the fan to blow the electric heating plate.

said motion status detector is a ball switch which can provide three kinds of status information: statically and horizontally placing/statically and vertically standing/motion; the automatic switch circuit comprises a heating switch\ a fan switch and a microprocessor; the microprocessor will calculate of horizontally placing time when said ball switch input the statically and horizontally placing information utill motion information be inputted and when the horizontally placing time is reach to a first time period, the microprocessor will control said heating switch to cut off the power of the electric heating plate and control the fan switch to connect to the power of the fan; or the microprocessor will calculate of the vertical standing time when the ball switch input the vertical standing static information until motion information be inputted and when the calculation of the vertical standing time is reach to a second time period, the microprocessor will controls the heating switch to cut off the power of the electric heating plate and control the fan switch to connect to the power of the fan.

Said microprocessor will calculate the working time of the fan and when the working time of the fan is calculated to a third time period, then the microprocessor will control the fan switch to cut off the fan power.

Said first time period is 30 seconds, said second time period is 3 minutes, said second time period is 15 minutes.

Said housing is provided with an air inlet, said fan is disposed in the tube mounted between said air inlet and said electric heating plate.

The automatically cooling iron of the present invention is to detect whether the iron is stopped by a motion status detector, once the iron is stopped, the motion status detector will provide a stopping signal to the automatic switch circuit, the automatic switch circuit will calculate the time of stopping and control the fan to blow to the electric heating plate. Although the electric heating plate has high temperature after ironing, the air flow provided by the fan can let the electric heating plate to be cooled rapidly so as to save time to be stored. Said motion status detector is a ball switch which can provide three kinds of status information: statically and horizontally placing/statically and vertically standing/motion; the automatic switch circuit comprises a heating switch\ a fan switch and a microprocessor; the microprocessor will calculate the horizontally placing time/vertical standing status information, if said ball switch input the statically and horizontally placing/motion/vertical standing information, and when the horizontal placing time or vertical standing time is reached to a predetermined value, the microprocessor will control the heating switch to cut off the power of the electric heating plate and control the fan switch to connect to the power of the fan. The method that respectively dealing with the situation of the horizontal placing or vertical standing in the stopping of the iron is match to the character of the iron that the stopping time is relatively short in horizontal placing status and is relatively long in vertical standing status. The control of the electric heating plate and the fan is much friendly. The microprocessor calculate the working time of the fan and control the fan switch to cut off the fan power if the working time is reach to a predetermined value. The automatically stopping operation of the fan is friend to users. In a preferred embodiment of the invention, the predetermined value of the horizontal placing is 30 seconds, the vertical standing predetermined value is 3 minutes and the predetermined time of the fan working time is 15 minutes, this is match to the requirement of the user and match to the heating temperature and the cooling time. The housing is provided with an air inlet and the fan is disposed on the tube mounted between the air inlet and the electric heating plate, this facilitates to improve the cooling efficiency.

### BRIEF DESCRIPTION OF THE DRAWINGS

FIG. 1 is an inside structure view of the automatically cooling iron of the present invention in a preferred embodiment.

FIG. 2 is an exploded view of the embodiment of FIG. 1

FIG. 3 is a circuit block diagram of the embodiment of FIG. 1.

FIG. 4 is a sectional view of the ball switch of the embodiment of FIG. 1.

FIG. 5 shows the vertical standing status of the ball switch in the embodiment of FIG. 1.

FIG. 6 shows the horizontal placing status of the ball switch in the embodiment of FIG. 1.

### DETAILED DESCRIPTION OF THE EMBODIMENTS

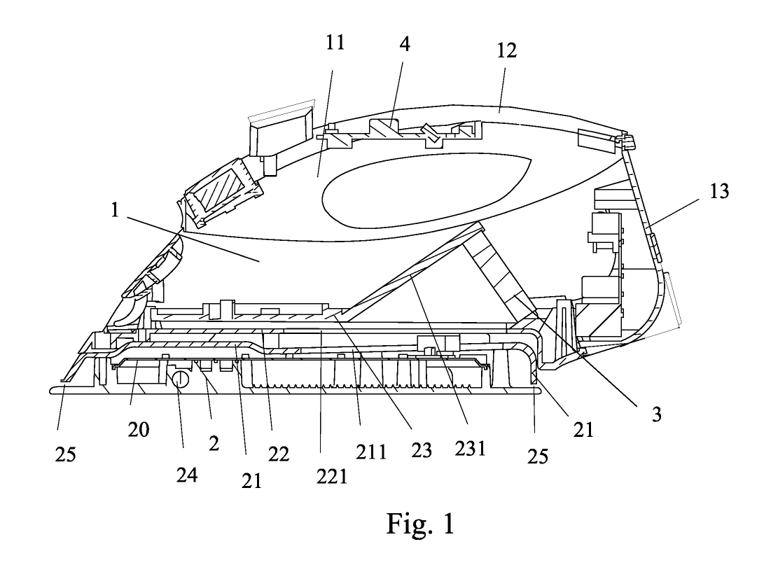

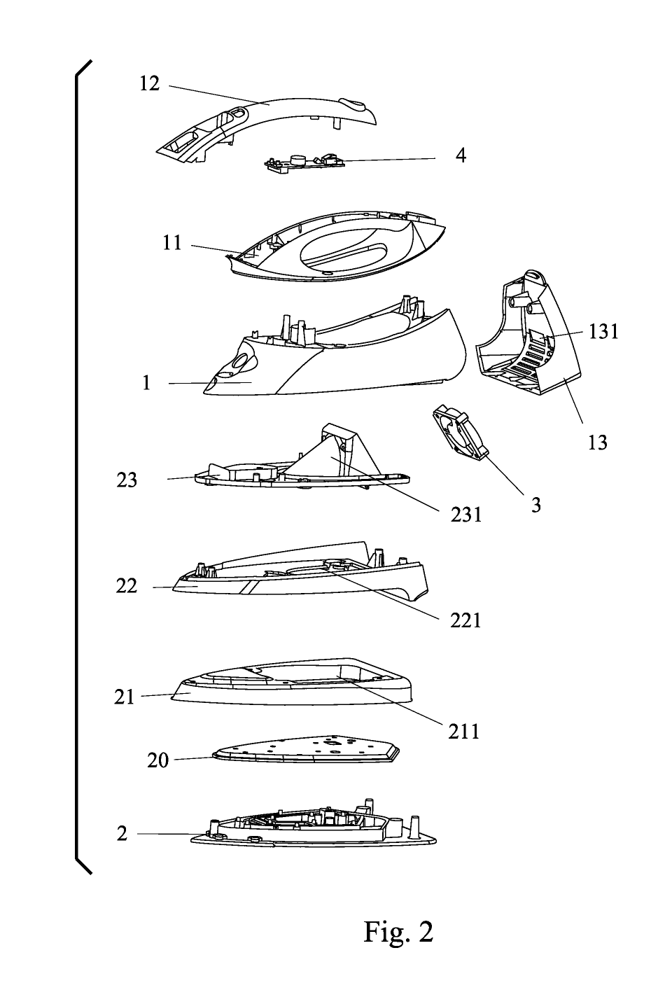

As is shown in FIG. 1 and FIG. 2, the automatically cooling iron comprises a housing 1, an electric heating plate 2, fan 3 and a circuit board 4.

A housing handle 11 with shell structure is disposed on the top of the housing 1, the circuit board 4 is disposed in the concave in the upper portion of the handle 11; the handle cover 12 is mounted on the top of the handle 11 to cover the inside of the handle. The rear portion of the housing 1 is disposed with a rear cover 13 which is provided with an air inlet 131. The housing 1, handle cover 12 and the rear cover 13 are all made by plastic and have good appearance and well heating insulation.

The electric heating plate 2 is made by aluminum alloy and is provided with a pre-embedded electric heating tube 24. The top of the electric heating plate 2 is riveted with a electric heating plate cover 20 to close the electric heating plate 2. A metal shell 21 for decoration is disposed on the upper of the electric heating plate cover 20. The metal shell 21 is a box with a downward opening, the rear portion of the top surface of the metal shell 21 is provided with a window 211, an interstice 25 for air flow is disposed between the side of the metal 21 and the electric heating plate 2. An insulation board 22 made by heat insulation material is disposed on the upper of the metal shell 21. The rear portion of the insulation board is provided with a window 221. The upper surface of the insulation board 22 is disposed with a supporting board 23, and the rear portion of the supporting board 23 is provided with an inclined tube 231.

The fan 3 is mounted inside the housing 1 and is located in the opening of the tube 231 in the rear portion of the supporting board 23 and is towards to the air inlet 131 of the rear cover 13.

The circuit board 4 is provided with an automatic circuit 41 and a ball switch 42.

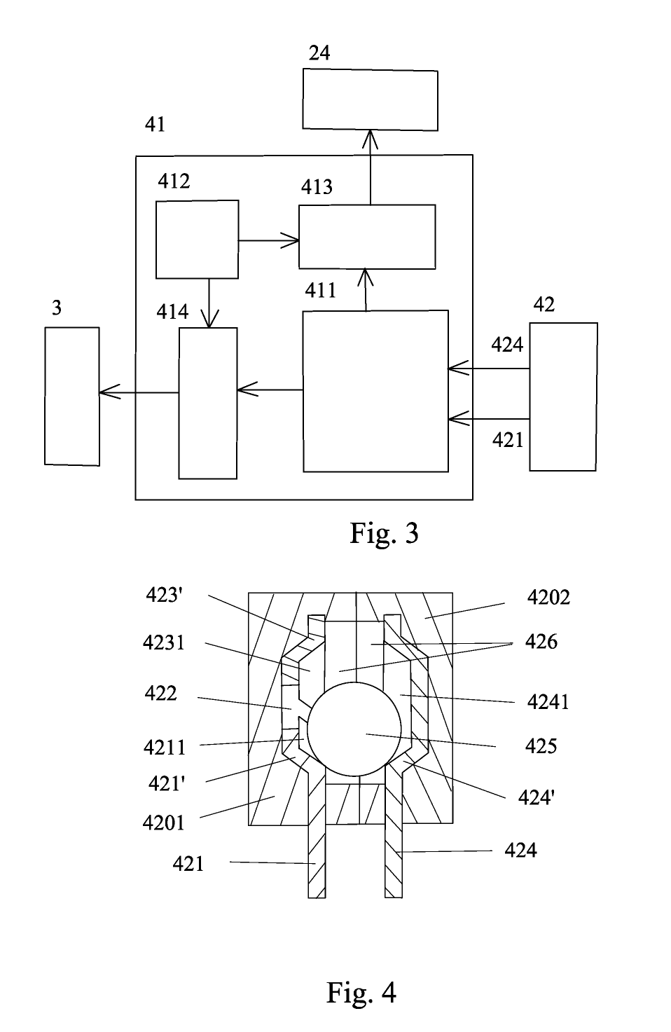

Referring to FIG. 3: the automatic switch circuit 41 comprises a microprocessor 411, an alternating current power 412, a heating switch 413 and a fan switch 414. The control input terminals of the microprocessor 411 are respectively connected to the first detecting output terminal 421 and a common terminal 424. The first control output terminal of the microprocessor 411 is connected to the control input terminal of the heating switch 413 and the second control output terminal of the microprocessor 411 is connected to the control input terminal of the fan switch 414. The alternating power 412 provides alternating power to the heating switch 413 and the fan switch 414. The output terminal of the heating switch 413 is connected to the heating tube 24 of the electric heating plate 2. The output terminal of the fan switch 414 is connected to fan 3.

Referring to FIG. 4, the opening end of the front shell 4201 is clamp to the opening end of the rear shell 4202 of the ball switch 42, thus an arc guiding chamber 426 is formed between them. A concave contacting piece is embedded in the concaved portion of the front shell 4201 (i.e. the front surface of the guiding chamber 426), correspondingly, a concave contacting piece 424′ with same size is embedded in the concaved portion of the rear shell 4202 (i.e. the rear surface of the guiding chamber 426).

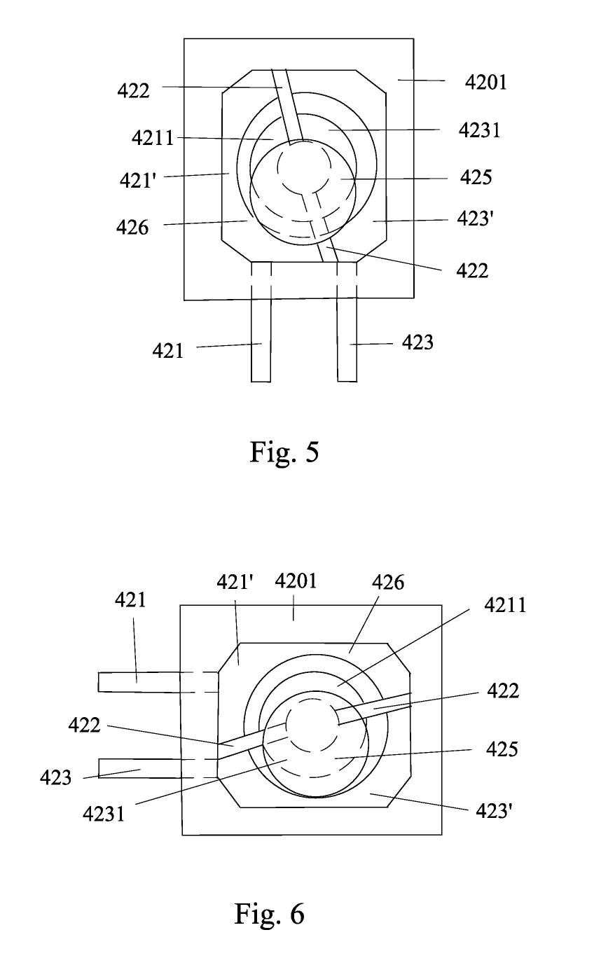

Referring to FIG. 5, the contacting piece of the front shell 4201 is separated into two portions along an direction oblique to the vertical axis by a separating groove 422, the first portion 421′ is connected to a first detecting output terminal 421 which is extending outwardly; the second portion 423′ is connected to a second detecting output terminal 423 which is extending outwardly; an electric ball 425 is disposed in the guiding chamber 426. The distance between the concave portions 4211/4231 of the contacting piece of the front shell 4201 of the guiding chamber 426 and the bottom of the concave portion 4241 of the contacting piece 424′ of the rear shell 4202 is bigger than the diameter of the electric ball 425.

When the ball switch 42 is in statically and vertically standing status, the electric ball 425 is connected to the first portion 421′ of the contacting piece of the front shell 4201 and the contacting piece 424′ of the rear shell 4202, thus the first detecting output terminal 421 is connected to the common terminal 424. While when the ball switch 42 is in moving vertical standing status, the electric ball 425 is jumped slightly between the first portion 421 of the contacting piece of the front shell 4201 and the contacting piece 424′ of the rear shell 4202, so that the first detecting output terminal 421 is connected and unconnected alternatingly to the common terminal 424.

Referring to FIG. 6, when ball switch 42 is in statically horizontally-placing status, the electric ball 425 is depart from the first portion 421′ of the contacting piece of the front shell 4201 but remains contacting with the contacting piece 424′ of the rear shell 4202, thus the first detecting output terminal 421 is un-connected to the common terminal 424. While when the ball switch 42 is in moving horizontally-placing status, the electric ball 425 is jumped slightly between the first portion 421 of the contacting piece of the front shell 4201 and the contacting piece 424′ of the rear shell 4202, thus the first detecting output terminal 421 is connected and unconnected alternatingly to the common terminal 424.

So the ball switch 42 can provide three status information: statically and horizontally placing, statically and vertical standing, and moving.

In normal ironing, when the iron is horizontally placed and statically. i.e. the ball switch 42 is in statically and horizontally placing status, the first detecting output terminal 421 and the common terminal 424 of the ball switch 42 are in connected status. The microprocessor 411 will startup the horizontally placing time when receive the statically and horizontally placing information from the ball switch. In this period, if the ball switch 411 receive the alternatingly connected and unconnected motion status information from the ball switch 42, then the calculation of the horizontally placing time is stopped. If the horizontally placing time is calculated to 30 seconds, then the microprocessor 411 controls the heating switch 413 to cut off the power of the electric heating plate 2 and controls the fan switch 414 to connect to the power of the fan 3. when the fan begin to work, the cooling air of the outside is input into the housing 1 through the air inlet 131 of the rear cover 13, then the air passes though the tube 231 of the rear portion of the supporting board 23, the window 221 of the rear portion and the window 211 of the rear portion of the shell 21, then the cooling air blows to the electric heating plate cover 20 of the electric heating plate 2, and bring out the heat of the electric heating plate 2, the hot air is then blow out from the interstice 25 between the side of the shell 21 so that the electric heating plate 2 is to be cooled. The microprocessor 411 then startup the calculation of the working time of the fan, when the working time is calculated to 15 minutes, the electric heating plate 2 is fully cooled; then the microprocessor 411 controls the fan switch 414 to cut off the power of the fan 3, and the fan 3 will be automatically stopped. Then the power cord can be removed from the power and the iron can be stored.

When the iron is in statically and vertically standing status. i.e. the ball switch 42 is in statically and vertically standing status, the first detecting output terminal 421 and the common terminal 424 of the ball switch 42 are in unconnected status. After the microprocessor 411 received the vertical standing information from the ball switch 42, then the vertical standing time calculation is startup; in this period, if the microprocessor 411 receive the alternatingly connected and unconnected motion status information from the ball switch 42, then stop the calculation of the vertical standing time. When the vertical standing time is calculated to 3 minutes, then the microprocessor 411 controls the heating switch 413 to cut off the power of the electric heating tube 24 of the electric heating plate 2 and control the fan switch 414 to be connected to the power of the fan 3. After the fan 3 being working, the cooling air of the outside is input into the shell 1 through the air inlet 131 of the rear cover 13, and then pass through the tube 231 of the rear portion of the supporting board 23, the window 221 of the rear portion of the insulation board 22 and the window 211 of the rear portion of the shell 1, blows to the electric heating plate cover 20 of the electric heating plate 2 so as to bring out the heat of the electric heating plate 2, and the hot air is then blow out from the interstice 25 between the side of the shell 21 and the electric heating plate 1, thus the electric heating plate 2 is rapidly cooled. The microprocessor 411 then startup the calculation of the working time of the fan, when the working time is calculated to 15 minutes, the electric heating plate 2 is fully cooled; the microprocessor 411 will control the fan switch 414 to cut off the power of the fan 3, thus the fan 3 will be automatically stopped. Then the power cord can be removed from the power and the iron can be stored.

Certainly, in the automatic switch circuit 41, the control input terminals of the microprocessor can also respectively connected to the second detecting output terminal 4231 and the common terminal 424, this also can achieve the control as described aforementioned, but this needs to change the mounting location of the ball switch 42. If the ball switch 42 is not used as a motion status detector, it also can use motion detector, horizontally placing detector, vertical standing detector to respectively provide the detecting information to the control input terminal of the microprocessor 411, but this will make the hardware system to be complex.

It will be apparent to those skilled in the art that various modifications and variations can be made in a water saving mechanism for a shower device of the present invention without departing from the spirit or scope of the invention. Thus, it is intended that the present invention cover the modifications and variations of this invention provided they come within the scope of the appended claims and their equivalents.

What is claimed is:

1. An automatically cooling iron comprising a housing, an electric heating plate disposed on the bottom of said housing, is characterized in that: the inside of the housing is disposed with a fan\ a motion status detector and an automatic switch circuit; said motion status detector provides the signal of the stopping of the iron to said automatic switch circuit, said automatic switch circuit is used to calculate the time of the stopping and controls the fan to blow the electric heating plate.

2. The automatically cooling iron according to claim 1, is characterized in that: said motion status detector is a ball switch which can provide three kinds of status information: statically and horizontally placing/statically and vertically standing/motion; said automatic switch circuit comprises a heating switch, a fan switch and a microprocessor; said microprocessor will calculate horizontally placing time when said ball switch input the statically and horizontally placing information until motion information be inputted and when the horizontally placing time is reach to a first time period, the microprocessor will control said heating switch to cut off the power of the electric heating plate and control said fan switch to connect to the power of the fan; or said microprocessor will calculate vertical standing time when said ball switch input the vertical standing static information until motion information be inputted and when the calculation of the vertical standing time is reach to a second time period, said microprocessor will control the heating switch to cut off the power of the electric heating plate and control said fan switch to connect to the power of the fan.

3. The automatically cooling iron according to claim 2, is characterized in that: said microprocessor will calculate the working time of the fan and when the working time of the fan is calculated to a third time period, then the microprocessor will control the fan switch to cut off the fan power.

4. The automatically cooling iron according to claim 3, is characterized in that: said first time period is 30 seconds, said second time period is 3 minutes, said second time period is 15 minutes.

5. The automatically cooling iron according to claim 1, is characterized in that: said housing is provided with an air inlet, said fan is disposed in the tube mounted between said air inlet and said electric heating plate.

6. The automatically cooling iron according to claim 2, is characterized in that: said housing is provided with an air inlet, said fan is disposed in the tube mounted between said air inlet and said electric heating plate.

7. The automatically cooling iron according to claim 3, is characterized in that: said housing is provided with an air inlet, said fan is disposed in the tube mounted between said air inlet and said electric heating plate.

8. The automatically cooling iron according to claim 4, is characterized in that: said housing is provided with an air inlet, said fan is disposed in the tube mounted between said air inlet and said electric heating plate.
